(19) United States
(12) Patent Application Publication
(10) Pub. No.: US 2025/0172472 A1
(43) Pub. Date: May 29, 2025

(54) FLUID ANALYSIS SYSTEM AND METHODS

(71) Applicant: The Johns Hopkins University, Baltimore, MD (US)

(72) Inventors: Stuart Campbell RAY, Baltimore, MD (US); Nicholas James DURR, Baltimore, MD (US); Benjamin D. HAEFFELE, Baltimore, MD (US); Rene E. VIDAL, Baltimore, MD (US); Gregory N. MCKAY, Baltimore, MD (US); Carolina PACHECO, Baltimore, MD (US); Taylor BOBROW, Baltimore, MD (US)

(73) Assignee: The Johns Hopkins University, Baltimore, MD (US)

(21) Appl. No.: 18/839,307

(22) PCT Filed: Feb. 17, 2023
(86) PCT No.: PCT/US2023/013335

§ 371 Date: Aug. 16, 2024

Related U.S. Application Data
(60) Provisional application No. 63/311,774, filed on Feb. 18, 2022.

(51) Int. Cl. G01N 15/01; G01N 15/1433; G01N 15/1434

(52) U.S. Cl. CPC G01N 15/01; G01N 15/1433; G01N 15/1434; G01N 2015/012; G01N 2015/016

(57) ABSTRACT

An analysis system for a translucent bodily fluid includes a flow chamber for the translucent bodily fluid defining an imaging section therein, an illumination source arranged to provide illumination light to said imaging section of said flow chamber, an optical sensor arranged proximate to said flow chamber and arranged to receive light after passing through said flow chamber, said optical sensor providing detection signals, and a processor arranged to communicate with said optical sensor to receive said detection signals therefrom. The illumination source provides at least partially coherent light to said imaging section of said flow chamber such that said detection signals correspond to a two-dimensional image, and the processor is configured to extract information from said two-dimensional image for particles when present within the translucent bodily fluid passing through said flow chamber.

### CROSS-REFERENCE OF RELATED APPLICATION

This application claims priority to U.S. Provisional Application No. 63/311,774, filed Feb. 18, 2022, which is incorporated herein by reference in its entirety.

### STATEMENT REGARDING FEDERALLY-SPONSORED RESEARCH OR DEVELOPMENT

This invention was made with government support under grant RO1 AG067396 awarded by the National Institutes of Health. The government has certain rights in the invention.

### BACKGROUND

### 1. Technical Field

Currently claimed embodiments of the invention relate to systems for analysis of translucent bodily fluids and related methods.

### 2. Discussion of Related Art

First documented more than 6,000 years ago, urinalysis is considered the first clinical laboratory test in medicine. Gross examination of turbidity, color, odor, and even taste were common. Since then, intricate physiologic details of the genitourinary tract have been described and powerful laboratory techniques to probe urine composition have been developed. Today, urinalysis is a critical diagnostic tool that reveals the chemical composition of urine in detail. Gross examination is still involved, but now the chemical composition, including nitrite, ketone, bilirubin, pH, protein, and glucose levels, and the presence of blood cells, crystals, and casts are quantified. The level or presence of each of these biomarkers can be either specifically diagnostic of a particular disease or otherwise paint a broader picture of patient health.

Collection and specimen handling of urine, as well as other translucent bodily fluids, represents a challenging aspect of such routine diagnostic tests. For example, urine is inherently unstable, and requires refrigerated storage in low-light conditions to prevent degradation of crystals, cells, casts, and to inhibit further bacterial growth.

Currently, urine analysis is ordered for symptomatic or high-risk patients. Urine is collected from a catheter or directly in a tube and sent to a laboratory for analysis. The urine is typically analyzed in several ways. The color and turbidity may be inspected by eye. A dipstick test might be used to measure acidity and the presence of protein, sugar, ketones, bilirubin and blood. The urine may also be centrifuged to concentrate and then viewed on a slide through a conventional microscope by a nephrologist or laboratory specialist to look for white blood cells, red blood cells, bacteria, casts, and crystals. Lastly, the urine may be sent to culture to test for small concentrations of bacteria. This workflow is problematic for many reasons: (1) it is slow and expensive, (2) it only provides a snapshot of the urine status at the time of collection, (3) it relies on subjective qualitative interpretation, (4) it samples a small volume of the urine at intermittent time intervals and may miss rare events that can be clinically consequential, such as red-blood cell casts (the presence of a single red-blood cell cast is always considered pathological).

Analysis of translucent bodily fluids such as urine has many potential applications. As an example, urinary tract infections (UTIs) are the most common hospital-acquired infection, and the vast majority are associated with catheter use, with over half a million-catheter associated UTIs in the US every year. Approximately $4 Billion USD is spent per year managing catheter associated UTIs. There are significant problems with both overdiagnosis and the over-use of antibiotics in managing UTIs, as well as late-diagnoses and prolonged catheterization that can lead to costly iatrogenic UTIs.

Therefore, there remains a need for new and/or improved systems and methods for analysis of translucent bodily fluids.

### SUMMARY

An embodiment of the present invention is an analysis system for a translucent bodily fluid, comprising a flow chamber for the translucent bodily fluid defining an imaging section therein; an illumination source arranged to provide illumination light to said imaging section of said flow chamber; an optical sensor arranged proximate to said flow chamber and arranged to receive light after passing through said flow chamber, said optical sensor providing detection signals; and a processor arranged to communicate with said optical sensor to receive said detection signals therefrom. The illumination source provides at least partially coherent light to said imaging section of said flow chamber such that said detection signals correspond to a two-dimensional image, and the processor is configured to perform a holographic reconstruction to extract information from said two-dimensional image for particles when present within the translucent bodily fluid passing through said flow chamber. The particulate classification and concentration measurements may also, in some embodiments, be inferred directly from the two-dimensional measurement without reconstruction, by analyzing the hologram spatial features. Moreover, the change in spatial position of the particulates in frames of a video measurement may be used to calculate volumetric flow rate of the fluid in the flow chamber.

Another embodiment of the present invention is an adaptive sparse reconstruction (ASR) method for lens-less digital holography, comprising receiving a two-dimensional diffraction image of a sample containing a plurality of optical scattering centers that have been illuminated with partially coherent light; and applying an unsupervised learning model to obtain phase retrieval, point spread function (PSF) estimation, and holographic reconstruction. The PSF is a generalized PSF that accounts for two-dimensional imaging through a system.

Another embodiment of the present invention is a method of analyzing a translucent bodily fluid in a chamber, comprising receiving a plurality of detection signals from an optical sensor arranged proximate to said chamber, said optical sensor arranged to receive light from an illumination source after said light passes through at least a portion of said translucent bodily fluid in said chamber; processing said signals to generate a two-dimensional image; and performing an adaptive sparse reconstruction to extract information from said two-dimensional image for particles when present within the translucent bodily fluid.

### BRIEF DESCRIPTION OF THE DRAWINGS

Further objectives and advantages will become apparent from a consideration of the description, drawings, and examples.

FIG. 1A shows an LFI analysis system for a translucent bodily fluid, according to some embodiments of the invention.

FIG. 1B shows a process for adaptive sparse reconstruction, performed in some embodiments by a processor of the LFI system in FIG. TA.

FIG. 1C shows a process for analyzing a translucent bodily fluid in a chamber, performed in some embodiments by the LFI system in FIG. TA.

FIG. 2 shows an example of a flow chamber of some embodiments.

FIG. 3 provides an overview of an LFI system of some embodiments, alongside a conventional ground truth (GT) microscope.

FIG. 4 Shows results of urinalysis control in low-melting point agar acquired with the LFI system of FIG. 3.

FIG. 5 shows red and white blood cell concentration estimation using the LFI system of FIG. 3.

FIG. 6 shows E. Coli concentration estimation using the LFI system of FIG. 3.

FIG. 7 shows red blood cell (RBC), white blood cell (WBC), and E. Coli concentration estimation in Bio-Rad urinalysis control using the LFI system of FIG. 3.

FIG. 8 shows LFI holograms of human urine negative UTI controls and positive UTI diagnosis, using the LFI system of FIG. 3.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed, and other methods developed, without departing from the broad concepts of the current invention.

All references cited anywhere in this specification, including the Background and Detailed Description sections, are incorporated by reference as if each had been individually incorporated.

The term “lens-free imaging” (LFI), as used herein, refers to a form of digital holography that has shown tremendous promise in biological applications. LFI is well-suited for the task of real-time analysis of biologic fluid due to its remarkably simple and compact nature. In LFI, a partially coherent light source may be used to trans-illuminate a weakly scattering sample, so that the diffracted portion of the illumination wavefront interferes with the non-scattered reference wavefront to produce holograms on a 2D sensor. Digital reconstruction algorithms that model the diffraction of light may be applied to the recorded hologram to enable image reconstruction at varying depth. LFI is not limited by the resolution and depth-of-field constraints of conventional lens-based microscopy, and thus a large-volume sample with an extended axial range can be reconstructed from a single hologram.

The term “translucent bodily fluid”, as used herein, refers to any liquid or fluid of biological origin. Equivalent terms include biologic liquid, bodily liquid, biologic fluid, etc. Examples of translucent biologic fluids that can be imaged using the LFI system include, but are not limited to, urine, synovial fluid, cerebrospinal fluid, vitreous humor, pleural effusion, peritoneal lavage, peritoneal dialysate, pericardial fluid, serous fluid, seminal fluid. These fluids are referred to as translucent because at least a portion of light at visible wavelengths that passes through these fluids are not absorbed, and may be detected passing through a sample, though the amount of light passing through the sample depends at least on the sample thickness, volume, and other characteristics such as clarity, sparsity, and flow rate. In some cases, a biologic fluid may be translucent at non-visible wavelengths, such as infrared, near infrared, or ultraviolet. In these cases, the fluid may still be referred to as a translucent fluid. In addition, certain biologic fluids including but not limited to blood may not be translucent initially, but may be rendered translucent by other processes (e.g., centrifugal separation).

Some embodiments of the current invention provide an LFI system capable of detecting particles important for analysis of translucent biologic fluids. In particular, some embodiments of the system are capable of recording holograms of flowing, sparse biologic liquid volumes. The system includes an imaging sensor and an illumination source capable of providing coherent light. An adaptive sparse reconstruction (ASR) method may be used by the system to recover a 3D reconstruction of the biologic liquid from a measured hologram.

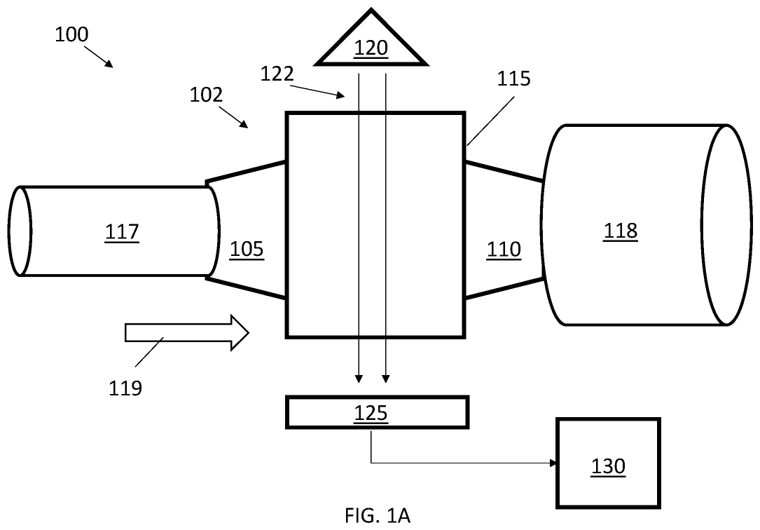

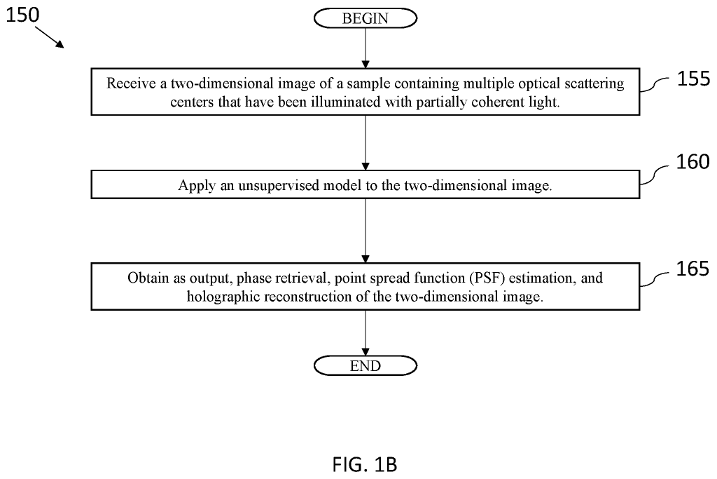

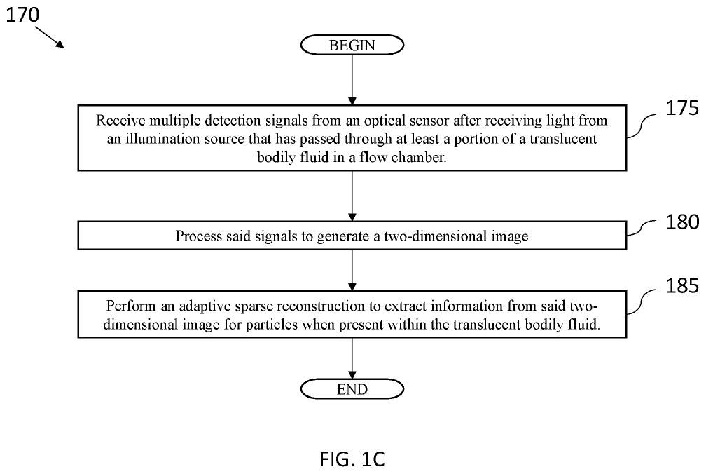

FIG. 1 shows an LFI system 100 for analysis of a translucent bodily fluid, according to some embodiments of the invention. The LFI system 100 includes a flow chamber 102 for the translucent bodily fluid, the flow chamber 102 having an entry port 105, an exit port 110, and an imaging section 115 in flow communication with the entry port 105 and the exit port 110.

The flow chamber 102 may be configured to attach to and to be detached from a catheter 117 (e.g., a urine catheter) at the entry port 105. The flow chamber 102 may be further configured to attach to and to be detached from a fluid collection device 118 (e.g., a urine bag) at the exit port 110. The direction of flow of fluid through the LFI system 100 is indicated by arrow 119.

The LFI system 100 also includes an illumination source 120 arranged to provide illumination light 122 to the imaging section 115 of the flow chamber 102, and an optical sensor 125 arranged proximate to the flow chamber 102. The optical sensor 125 is arranged to receive light from the illumination source 120 after the light has passed through the flow chamber 102.

In some embodiments, the illumination source 120 includes at least one substantially monochromatic light-emitting diode (LED), with a pinhole aperture stop arranged between the LED and the imaging section 115 of the flow chamber 102. In some embodiments, the illumination source 120 includes at least one laser diode directed onto the imaging section 115 of the flow chamber 102. The illumination source 120 may be capable of emitting light at multiple different wavelengths directed onto the imaging section 115 of the flow chamber 102. For example, the illumination source 120 may include multiple LEDs or laser diodes of varying frequencies. The pinhole size may also vary in some embodiments, among sources to create holographic images with different coherence lengths that provide tunable sensitivity to small particles (with diameters of 100 nanometers to 100 micrometers) or dynamic ranges of particulate concentrations (from 0.1 particle per microliter to 108 particles per microliter). This pinhole size may range from 10 micrometers in diameter to 10 millimeters in diameter.

The optical sensor 125 is communicatively connected to a processor 130, and the processor 130 receives detection signals from the optical sensor 125. The illumination source 120 provides at least partially coherent light to the imaging section 115 of the flow chamber 102, such that the detection signals correspond to a two-dimensional image. The processor 130 is configured to extract information from the two-dimensional image for particles when present within the translucent bodily fluid, as the translucent bodily fluid passes through the flow chamber 102.

The information extracted from the two-dimensional image may include but is not limited to at least one of an output, a flow rate, a translucence, a clarity, and a sparsity of the translucent bodily fluid. The particles that can be detected and from which information may be extracted include, but are not limited to, red blood cells, white blood cells, casts, bacteria, fungi, parasites, ascites, tumor cells, and birefringent crystals (e.g., uric acid, calcium pyrophosphate).

In some embodiments, the processor 130 is configured to extract the information from the two-dimensional image by performing an adaptive sparse reconstruction (ASR). FIG. 1B shows a process 150 for adaptive sparse reconstruction, performed in some embodiments by the processor 130 of the LFI system 100 in FIG. TA.

The process 150 begins at 155 by receiving a two-dimensional image, of a sample containing a multiple optical scattering centers that have been illuminated with partially coherent light. The two-dimensional image may in some embodiments be generated by the processor 130, after receiving detection signals from the optical sensor 125. The detection signals are provided to the processor 130 by the optical sensor 125, after the optical sensor 125 receives the partially coherent light from the illumination source 120, after the light has passed through at least a portion of a translucent bodily fluid in the flow chamber 102.

At 160, the process 150 applies an unsupervised model to the two-dimensional image. For example, the two-dimensional image may be used as input to a machine learning model that has been previously trained on multiple two-dimensional images corresponding to one or more translucent bodily fluids, as described above.

In some embodiments, applying the unsupervised model includes solving an optimization problem. The optimization problem may in some embodiments be represented by Equation (1):

$${min}_{{\{ {X}_{j} \}}_{j = 1}^{D} , W , μ} \frac{1}{2} {‖ H ⊙ W − μ 1 − {\sum }_{j = 1}^{D} T ( z [ j ] ) ⋆ {X}_{j} ‖}_{F}^{2} + λ {\sum }_{j = 1}^{D} {‖ {X}_{j} ‖}_{1} s . t . \vert W \vert = 1. \qquad ( 1 )$$

Here, H is the hologram recorded by the image sensor, Xⱼ is the corresponding image at specified depth z[j], W is the estimated phase, p is the non-zero background modeling planar illumination, T (z) is the diffraction transfer function according to a wide angular spectrum model, and k is the sparsity parameter.

In some embodiments, the optimization problem may be represented by Equation (2):

$${min}_{W , \tilde{B} , T} {l}_{τ} ( ( H ⊙ W ) ⋆ {T}^{⋆} − \tilde{B} ) s . t . \vert W \vert = 1 , {‖ ℱ \{ \tilde{B} \} ‖}_{0} \leq β , \vert ℱ \{ T \} \vert = 1. \qquad ( 2 )$$

Here, I_{τ}(·) denotes the Huber loss function with parameter τ, \tilde{B}∈ [symbol] ^{m×n} models the spatial variation of the background, and the number of non-zero coefficients in the frequency domain, given by ∥ [symbol] {\tilde{B}}∥₀, is constrained by β. Also, the PSF, T, is incorporated as an optimization variable and is enforced to define a unitary operator by constraining its Fourier coefficients to lie in the unit circle ( [symbol] {T}|=1), and T* denotes the complex conjugate of the PSF.

At 165, the process 150 obtains as output from the learning model, one or more of a phase retrieval, a point spread function (PSF) estimation, and a holographic reconstruction, of the two-dimensional image. The PSF is, in some embodiments, a generalized PSF, that accounts for two-dimensional imaging through a system. The process 165 then ends.

FIG. 1C shows a process 170 for analyzing a translucent bodily fluid in a chamber, performed in some embodiments by the LFI system 100 in FIG. TA.

The process 170 begins at 175 by receiving multiple detection signals from the optical sensor 125, after receiving light from the illumination source 120 that has passed through at least a portion of a translucent bodily fluid in the flow chamber 102.

At 180, the process 170 processing the detection signals to generate a two-dimensional image.

At 185, the process 170 performs an adaptive sparse reconstruction to extract information from the two-dimensional image for particles when present within the translucent bodily fluid. The adaptive sparse reconstruction may in some embodiments be the process 150 as described above with reference to FIG. 1B. The process 170 then ends.

The following describes some alternatives and details of various embodiments of the current invention by way of example and are not intended to limit the broad concepts of the current invention.

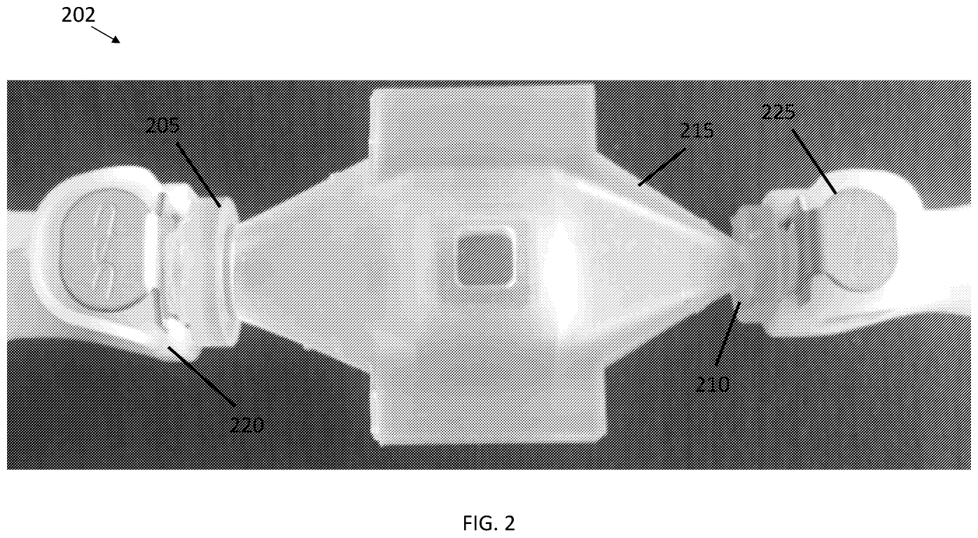

FIG. 2 shows an example of a flow chamber 202 of some embodiments. The flow chamber 202 may be used, as a non-limiting example, as the flow chamber 102 of LFI system 100 (FIG. 1). The flow chamber 202 has an entry port 205, an exit port 210, and an imaging section 215. In some embodiments, the flow chamber 202 has a circular cross section at the entry port 205 and the exit port 210, which can be connected to a standard catheter 220 and drainage bag 225, and the channel changes to a rectangular cross section at the imaging section 215 to allow imaging over a wide field of view. The flow chamber 202 has a gradual change in the cross sections between the entry port 205 and the imaging section 215, and between the imaging section 215 and the exit port 210. The gradual change and a longer flow chamber can reduce turbulent flow, which helps with accurate liquid output estimates and absolute particle concentration accuracy without increasing resistance to flow.

In some embodiments, including the example of FIG. 2, the imaging section 215 of the flow chamber 202 defines a substantially rectangular lumen therein, that is arranged to have a flat surface oriented substantially orthogonal to illumination light from the illumination source 120. The thickness of the rectangular lumen may be thinner in the direction of light travel from the illumination source 120 to the optical sensor 125, and thicker in a direction that is orthogonal to the direction of light travel, and orthogonal to the direction of flow of the translucent bodily fluid through the imaging section 215. As an example, the chamber thickness at the imaging section may be 0.1 mm (in the direction of light travel) to 20 mm thick (in the orthogonal direction).

### Multispectral Illumination

Some embodiments of the invention include a multispectral illumination source and a multispectral sensor to simultaneously detect different channels of information.

For example, in some embodiments, a blue channel may be used to detect bacteria, a green channel may be used to detect larger particles, and a red channel may pulse at a time delay to the green channel to get flow information.

Alternatively, in some embodiments, different wavelengths of light can illuminate the sample from different angles to enable triangulation during reconstruction, improving particle localization and resolution.

Shorter wavelengths (e.g., ultraviolet) may also be used in some embodiments to enable diffraction and measurement of smaller particles and cells. An ultraviolet-sensitive sensor and quartz/UV-transparent coverslips may be used as needed in such cases.

Multispectral information may be combined in some embodiments to classify particles in the liquid volume based on spectral response. This may be helpful for differentiating smaller particles with shapes that are difficult to interpret due to resolution limitations in the system (e.g., bacteria type).

Specific wavelengths at red blood cell absorption peaks may also be included in some embodiments for detecting the presence of red blood cells or red blood cell casts in the urine.

### Flow Estimation

Some embodiments, especially embodiments directed to urinalysis, estimate or compute flow rates from sequential images or multispectral images taken with time-spaced illumination and particle tracking using the 3D volume reconstruction. The flow rate can be used with knowledge of the flow chamber cross-section area to compute and report output (e.g., urine output) over time.

In some embodiments, the illumination source pulse width, and/or camera exposure time can be shortened (e.g., pulsed at short durations) to reduce motion artifacts.

In some embodiments, texture analysis of the raw (e.g., measured) hologram may be used to estimate flow rates with less processing than from the reconstructed volumes. More phase contrast implies slower flow. Multiple holograms may be acquired with different exposure times to improve the accuracy of the flow estimate. Scatterer sizes/concentrations may also be semi-regularly estimated through sparse reconstruction. This information can then be used when making the flow estimate from raw holograms to account for the contribution of scatterers, therefore improving the accuracy.

### Flow Chamber Design

In some embodiments, an LFI imaging system may use disposable flow chamber cartridges, such that the sparse biologic media (e.g., a translucent bodily fluid such as urine) flow through the cartridge for imaging. The more costly components of the imaging system (e.g., the detector, the light source, processor, etc.) would be reusable.

The general shape in some embodiments may have a U-shaped design, with entry and exit ports on the same side. The flow chamber cartridge may be inserted into the imaging system through a slot or opening.

In some embodiments, the flow chamber may be provided in sterile packaging, to be opened for each sample or patient in order to prevent cross-contamination. To reduce the risk of broken connections or contamination, the flow chamber can be fused/combined with the collection system (e.g., the bag, etc.). An adhesive, including but not limited to cyanoacrolyte permanent glue, may be used to make the connection between the bag and flow chamber, to prevent re-use and infections.

In preferred embodiments, the chamber thickness at the imaging area may range from 0.1 mm to 20 mm. Some embodiments may be made to work with many different catheter brands and sizes, by varying the chamber size and ingress/egress ports while the imaging area size remains constant. Some embodiments may use magnets to align with other magnets built into the imaging system, for mounting and to ensure proper alignment.

In some embodiments, especially embodiments directed to urinalysis, the flow chamber may be oriented at an angle to the flow (e.g., 45 degrees in preferred embodiments) to reduce bubble and urine accumulation. Bubbles and stagnant urine may cause image artifacts during image reconstruction. An accelerometer may be used to sense the orientation of the urine monitor, and alert the user when it should be adjusted.

The cross section in some embodiments may be shaped like a dog bone, with an escape area for bubbles and extra room for larger volumes of urine while maintaining an appropriate sample thickness in the center for imaging. The cross-section may transition from a circular cross-section at the entry and exit ports (for connection with tubing) to a rectangular cross-section at the imaging section to allow imaging over a wide field of view.

Some embodiments include a battery that is used to power the device. In some embodiments, the battery is replaced with each new flow chamber. Some embodiments have a syringe form-factor, in which the flow chamber is built into a syringe for imaging during withdrawal of fluid (e.g., CSF fluid).

### Flow Management

Some embodiments provide a bedside or laboratory LFI system that includes a reservoir and an active pump to force steady flow during analysis. Such a system may utilize a gravity pump to pass the liquid through the flow chamber from a reservoir at a constant velocity. A plunger may also be used to pass samples through the flow chamber from a reservoir. This may be a preferred embodiment for higher-viscosity samples (e.g., semen).

In some embodiments, the plunger may either be motorized or manually driven (e.g., in a field-compatible device embodiment). A one-way valve may be used to create unidirectional flow and prevent backflow into the catheter.

Some embodiments estimate volume output to obviate the need for collection in a bag. For example, in embodiments directed to urinalysis, urine could drain directly from the flow chamber into a drain/bucket, which would reduce nurse effort.

In various other embodiments, a baffle may be used to prevent backflow and bubbles, so that excess biologic liquid may enter the baffle while maintaining a steady stream through the imaging section. A semi-permeable membrane may be used to isolate white blood cells. Also, a stain-eluting coating or upstream tab may be used to identify bacteria types or general classes (e.g., bacteria vs. fungus).

### Signal Processing

Some embodiments use advanced holographic reconstruction methods to correct for optical imperfections in the imaging system. For example, some embodiments estimate bacteria concentration by analyzing the texture of the original hologram or the residual image once large particles have been reconstructed. In some embodiments, automated analysis using computer vision and machine learning algorithms may be applied to the raw hologram texture, and/or full image reconstructions may be implemented to provide concentration estimation of relevant clinical biomarkers such as red blood cells, white blood cells, crystals, casts, yeast, and other debris and pathogens. Each of these may be made more precise and informative in some embodiments, by classifying particulates (e.g., the system could be trained to recognize signals from different crystals, for example), blood cells (e.g., WBC versus RBC, single or in casts, normal or crenated), and microorganisms (e.g., bacteria versus yeast).

In some embodiments, the system may be a “learning system” that increases in clinical accuracy and relevance over time with clinician feedback.

In some embodiments, the system may be conditioned on patient-specific or site-specific information, such as but not limited to the gender, age, or weight of the patient, in order to improve the accuracy of the biomarker estimation.

Some embodiments implement longitudinal texture analysis that tracks changes in signal texture over time. As an example, an alarm may be issued when patient urine becomes filled with particles. This may also be a trigger for generating a full reconstruction, which would conserve battery and reduce the collection of uninformative data.

Some embodiments connect to a cell phone to display trends, communicate data to the clinician, etc. Some embodiments could utilize cloud computing for making estimates, performing reconstructions, etc.

Some embodiments of the current invention are directed to methods to process recorded image/video data. These methods include methods for solving an image reconstruction problem which produces microscopic images of translucent bodily fluids from raw recorded data, and additional methods to detect and quantify relevant objects and particles. Some embodiments provide novel reconstruction methods which learn and correct for image artifacts, system characteristics, and imperfections as part of the image reconstruction process, to improve the quality of the reconstructed images. Some embodiments provide methods that regress particle concentrations for particles which are below the resolution limits of the system.

### Anti-Fouling

Some embodiments include a brush or sponge, external or internal to the flow chamber, to allow active cleaning of the optical surfaces. An internal cleaning mechanism may use a magnet-driven wiper, where the wiper may be housed in the flow chamber, and translated using a magnet built into the imaging section.

Some embodiments automatically correct for background objects like adhered cells or particles in the recorded holograms.

Some embodiments alert the user of surface fouling that requires replacement or cleaning. The chamber may also be coated in an anti-fouling coating.

### Device Embodiment

In some embodiments, the LFI system may be provided as an LFI device. Such an LFI device may be compact and lightweight enough to be packaged in a small and portable housing that can be mounted directly to the bedside or to a portable IV stand. The LFI device may also be mounted to a leg-mounted drainage bag holder.

In some embodiments, the LFI device may include an alarm providing audio and visual feedback on the system. The alarm may provide a notification when trends in any clinically-important parameter (e.g., bacterial counts, WBC counts, etc.) increase or decrease too rapidly.

In some embodiments, the imaging system of the LFI device may be built directly into the wall or input port of a drainage bag and sold as an integrated, single unit. In such embodiments, the LFI device only needs to connect to a catheter on one side.

Some embodiments of the LFI device provide a disposable flow chamber cartridge and reusable imaging system. The flow chamber may come in sterile packaging to be opened for each patient, and the imaging system (with the detector, light source, and computer) may be reused. Such a replaceable/disposable flow chamber is advantageous not only for preventing cross-contamination, but also for allowing one reusable imager to work with many different catheter sizes (the cartridge could be variable diameter while the reusable system could be constant).

In some embodiments, a reusable part of the LFI device may include a screen to display trends of parameters, including but not limited to particulates, blood cell counts, and microorganism counts. Data may be read from the device for viewing on a computer, cell phone, etc. via a hardwire connection, network connection, Bluetooth, etc.

Some embodiments include a calibration target that is used to calibrate and verify that the LFI device is working correctly. The target may come in a similar form factor as a flow chamber cartridge for insertion into the LFI device.

Some embodiments include an interlock switch to detect whether the flow cartridge is properly inserted into the system. Embodiments of an interlock switch may include, but are not limited to, a physical switch, a reed switch sensitive to magnets, and a beam switch.

Some embodiments include an ID chip reader for communication with the flow cartridge to check for compatibility, expiration date, etc.

Some embodiments, especially embodiments directed to urinalysis, include an accessory port to introduce stains to the urine. The LFI device may also include an additional flow chamber for performing these measurements. This may be useful for identifying eosinophils, for example.

In some embodiments, the LFI device may include one or more additional sensors, and perform sensor fusion to obtain additional information.

For example, some embodiments use an accelerometer to sense the orientation of the LFI device. When coupled communicatively to a user interface and a processor, signals from the accelerometer may be used to alert the user when the LFI device orientation should be adjusted, and filter (e.g., drop) frames that are acquired during large changes in device orientation.

Some embodiments use a flow sensor to measure the velocity of the liquid flowing through the LFI device. Frame recording may be limited to when a change in flow is detected to conserve battery life and reduce collecting uninformative data.

Some embodiments use a temperature sensor to measure the temperature of the flowing liquid. This may be paired with a solid-state thermoelectric cooler (TEC) for heating/cooling the liquid to a desired temperature. This may be useful for preventing crystal formation in urine, minimizing fouling, etc. Some embodiments may determine central temperature from the urine. Some embodiments use flow to estimate the reliability of temperature. The temperature may be more reliable at higher flow rates when it has less time to cool outside the body.

Some embodiments use a photodiode to measure color and turbidity. Blood may be detected in urine with blue/green absorbance.

Other sensors may be used in some embodiments to measure other liquid parameters including but not limited to pH, Electrical impedance, and the Coulter effect.

### Application: Bedside Urinalysis

In some embodiments, especially embodiments directed to urinalysis, some embodiments of the invention provide a bedside device for urinalysis. Some embodiments of the bedside device enable real-time, non-invasive, low-cost, quantitative analysis of all excreted urine from a patient. As an example, some embodiments enable urinalysis directly in-line with a foley catheter. Urine draining through a foley catheter in a passive in-line configuration may be directly imaged and enable continuous, real-time temporal trend analysis of urine output while alleviating issues with urine handling, transportation, storage, and processing.

Some embodiments provide continuous or continual monitoring of urine content or volume, which are standard measures that are not currently available through standard practice in real-time.

In some embodiments, a large volume of phantom urine can be imaged by the system at flow rates typical of catheterized patient urine output. As a non-limiting example, in some embodiments, samples of up to 2 mm thickness may be imaged at flow rates in excess of 1 mL/minute. As another non-limiting example, contrast may be obtained in some embodiments from particles as small as 0.5 μm (e.g., E. Coli).

The system may enable screening and provide early indicators for diseases such as urinary tract infection (UTI), kidney disease, and other conditions. Examples of applications include UTI management and prevention, monitoring of kidney health for catheterized patients in an intensive care unit (ICU) or post-surgery, optimizing catheter duration (e.g., in nursing homes), and assessing hydration status.

Some embodiments enable clinical data to be provided with minimal clinician intervention, and can provide indications of developing pathology early enough to allow for mitigation by simple catheter removal rather than requiring more invasive treatments (e.g., antibiotic usage).

In some embodiments, the urine output and other parameters may be used to adjust infusion pump parameters for a closed-loop, optimized delivery of fluids and maintenance of hydration. In particular, for congestive heart failure, there is a need to control hydration very closely. The interval between monitoring and control may be reduced with real-time fluid monitoring and IV control. For patients with fluid in the lungs, it is important to remove fluid as quickly as possible but also need to maintain minimum hydration. For these patients, the bedside device can therefore be used for controlled diuresis. Additional advantages include reducing bedside care burden, obviating more frequent assessments of the bedside urine collection system.

Some embodiments include a wireless connection to log urine information to electronic medical records, and suggest the ordering of a conventional urinalysis or other standard-of-care clinical diagnostic test. The remote capability may further enable remote monitoring and clinical consultation, as well as centralizing and standardizing more sophisticated data interpretation of volume and content of urine.

Continuous and remote monitoring of urine output in some embodiments provide several advantages. For example, such monitoring may enable detection of hemodynamic changes, such as dehydration or rapid gastrointestinal bleeding, that can go undetected for hours otherwise. The kidneys are exquisitely sensitive to changes in intravascular volume.

Such monitoring may also enable response (or lack of response) to diuretic treatment at far higher resolution (in time) than currently possible. The pace and volume of response is a strong indication of the appropriateness of dosing, but is often unavailable. This could revolutionize diuretic management in people with fluid overload.

Continuous and remote monitoring of urine content may also enable early events in the development of urinary tract infection, a major source of iatrogenic morbidity, prolonged hospitalization, metastatic infection (e.g. in orthopedic patients), and hospital costs. Earlier awareness of inflammation in the urinary system may be determined in some embodiments before a UTI develops, which may prompt earlier consideration of appropriate removal of the urinary catheter (a major goal of inpatient safety and antibiotic management programs).

Some embodiments enable early detection of adverse drug events, which may cause changes in urine sediment that may not be apparent on gross visual inspection of urine (e.g. crystalluria).

### Application: Laboratory Urinalysis

In some embodiments, the LFI system may be a laboratory instrument that automates and simplifies the process of urine analysis in the laboratory.

Some embodiments of the current invention may enable or simplify microscopic urine analysis. In particular, some embodiments of the invention may enable microscopic analysis of large volumes of urine without the need for centrifugation or the addition of contrast agents. For example, an image sensor may be placed close to a chamber of urine, illuminating the urine with a partially coherent light source, and the resulting video data processed to reconstruct particulates and estimate concentrations of clinically relevant parameters.

### Application: Point-of-Care Urinalysis

In some embodiments, the LFI system may be implemented as an at-home wellness monitor for users to track hydration status and other trends in urine output and kidney function. For example, the LFI system may be implemented at least partially on a mobile phone platform or with a low-cost sensor and microcontroller for testing urine in remote and low-resource settings.

### Application: Other Diagnostics

In some embodiments, other bodily fluids than urine may be imaged and analyzed, especially translucent bodily fluids including but not limited to synovial fluid, cerebrospinal fluid, vitreous humor, pleural effusion, peritoneal lavage, peritoneal dialysate, pericardial fluid, serous fluid, and seminal fluid. Any or all of these biologic liquids may be analyzed for red blood cells, white blood cells, casts, bacteria, fungi, parasites, ascites, tumor cells, birefringent crystals (e.g., uric acid, calcium pyrophosphate), or other relevant clinical biomarkers.

For example, spinal fluid imaging may be performed in drains and shunts, to detect infections by imaging fluids (e.g., the presence of WBCs would indicate infection). Shunt-based imaging may be used for detection or diagnosis of hydrocephalus, for example. In addition, headaches may be caused by incorrect flow rates or improper flow. As another example, imaging of vitreous fluid in ophthalmic surgical applications may be performed. Another example is during lumbar puncture—where a few drops into the imaging section may provide bacteria or WBC counts.

Some embodiments enable the monitoring of dialysis effluent, such as in peritoneal dialysis. Analyzing this fluid for particulates (e.g., macrophages or other blood cells, and E. coli or other bacteria), as well as volumetric flow rates could be used to detect infection and optimize fluid exchange rates.

Some embodiments enable rheumatology joint fluid analysis, enabling a decision on steroid treatment during the fluid sample. Birefringent crystals may also be detected to discriminate between gout and pseudo-gout.

Some embodiments may be applied during paracentesis, where during a drain abdominal cavity of peritoneal fluid, the drawn fluid may be imaged to detect ascites.

Some embodiments may be applied during thoracentesis. A plural effusion, low pH (e.g., infection), and tumor cells may be detected.

Some embodiments may be applied during bone marrow sampling, to aspirate biopsies. In these examples, the fluid may be imaged while removing. This may also apply to breast, thyroid, and lymph node biopsies. Imaging extracted fluid during these procedures in some embodiments may confirm a workable biopsy and assist a cytologist to confirm a viable biopsy.

Some embodiments may be applied during a pleur-evac, to measure fluid coming from the chest. For joint fluid, in addition to cell counting and detection of pathogens (e.g., bacteria, fungi, parasites, etc.), some embodiments may determine color and polarization, that may be used to differentiate clinically-important crystals such as uric acid (gout) from calcium pyrophosphate (pseudogout). Some embodiments provide real-time feedback to guide intra-articular drug administration more rapidly at lower risk.

Any of the various features discussed with any one of the embodiments discussed herein may also apply to and be used with any other embodiments.

The following provide more details and examples according to some embodiments of the current invention. The general concepts of the current invention are not intended to be limited to the particular examples. While various embodiments of the present invention are described below, it should be understood that they are presented by way of example only, and not limitation. Thus, the breadth and scope of the present invention should not be limited by any of the described illustrative embodiments but should instead be defined only in accordance with the following claims and their equivalents.

Some embodiments provide a new workflow for urine screening using holographic lens free imaging (LFI) that may be implemented directly at the patient bed-side. This approach enables rapid, point-of-care screening of large volumes of urine without laboratory equipment. An LFI system is described herein that is capable of resolving and estimating the concentration of important urine clinical biomarkers such as red blood cells, white blood cells, crystals, casts, and E. Coli, the most common cause of UTI. The LFI system is used to distinguish human UTI-positive urine from UTI-negative control urine samples. Experimental results show promise for LFI as tool for urine screening, potentially offering early, point-of-care detection of UTI and other pathological processes.

Some embodiments may be implemented directly in-line of a catheter drainage tube, allowing urine to be probed during micturition, and warning clinical staff to trending changes in urine composition in real-time. Some embodiments enable low-cost, point of care urinalysis screening in low-resource settings.

### II. Methods

### A. Optical System

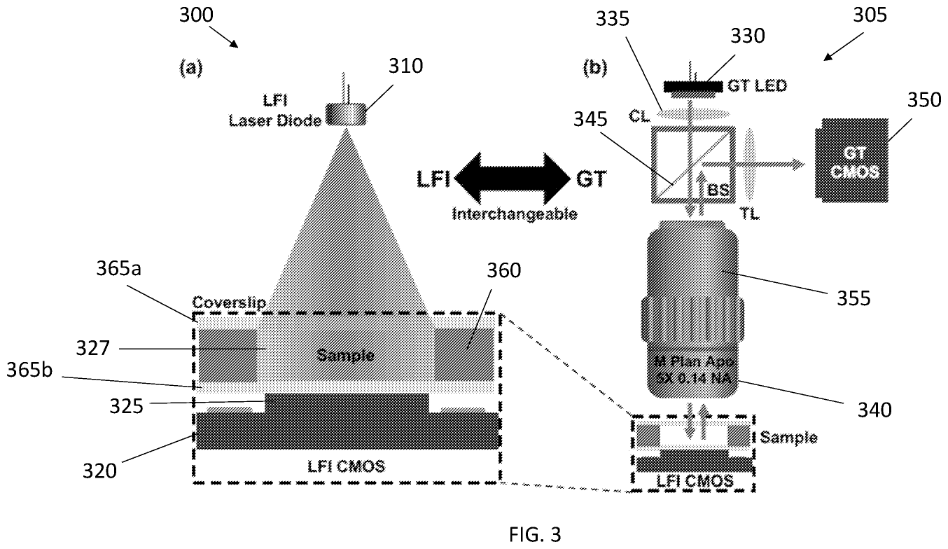

FIG. 3 provides an overview of an LFI system 300 of some embodiments, alongside a conventional GT microscope 305. In this example, the LFI system 300 consists of a 405 nm laser diode 310 (Thorlabs, L405P20) placed 8 cm away from a CMOS monochrome board camera 320 (The Imaging Source, DMM 37UX226-ML, 1.85 μm pixel pitch). A short, visible wavelength of 405 nm is chosen such that the silicon-based sensor 325 of the camera 320 has high quantum efficiency, and E. Coli (typically 0.5×1-2 μm [20]) may still propagate diffracted light to the sensor 325. The sensor 325 here provides a 7.4 mm×5.55 mm field-of-view, and given a sample 327 of 2 mm height, enables the acquisition of holograms over a sample volume of approximately 82 μL. The conventional, lens-based GT microscope 305 was built in epi-mode to enable sequential, paired imaging of the same particles between the two systems.

In this example, the GT microscope 305 includes a 465 nm LED 330 (Thorlabs LED465E, LEDMTlE) whose light is collected through a condensing lens illuminator module 335 (Thorlabs WFA2001), and reflected through the 5×0.14 NA Mitutoyo microscope objective 340 by a 50:50 beamsplitter 345 (Thorlabs BSW10R). Back-scattered light is collected by the same objective 340, and imaged onto the GT CMOS 350 (Edmund Optics EO-5012M) by an f=200 mm tube lens 355 (TL). The GT microscope 305 is mounted on a z-axis motorized module (not shown) (Thorlabs ZFM2020 and MCM3001) to enable z-stack acquisition.

In this example, the laser diode 310 and the GT microscope objective 340 are both mounted on a rotating turret (Thorlabs CSN510 nosepiece, not shown) to enable interchanging between the two imaging systems without moving the sample. Custom software written in MATLAB is used to control the imaging system. Together, this setup enables the acquisition of paired conventional lens-based images with lens-free holo-graphic reconstructions.

### B. Sample Preparation

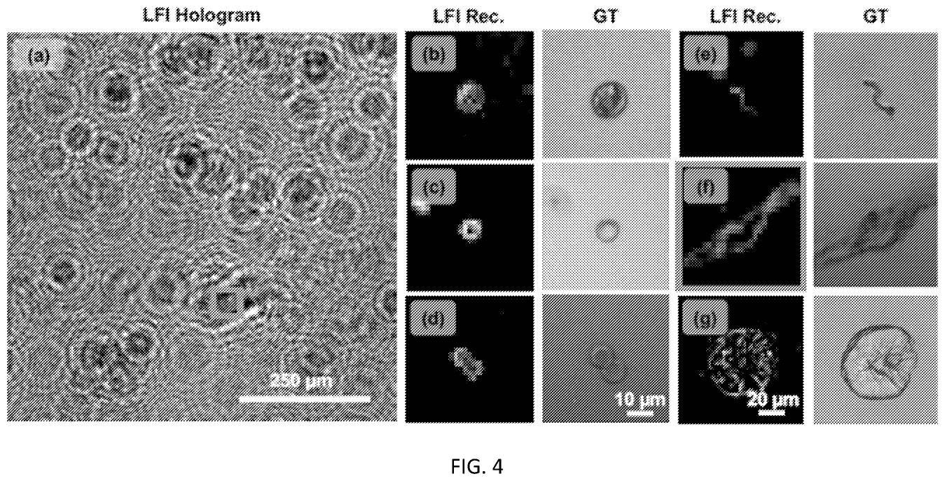

1) Paired LFI and GT Imaging: For each of the data presented herein, samples were prepared in a 2 mm deep silicone isolator well (Grace Bio Labs, CWS-13R-2.0) placed between two 22 mm×22 mm square #1 coverslips (Tedpella, 260341). A urinalysis control was used to model pathologic human urine (Bio-Rad Liquichek Urinalysis Control Level 2 #437). This is a commercially available assayed liquid urine phantom used to calibrate clinical urine dipstick and microscopic tests that contains primarily red and white blood cells, as well as intermittent crystals and casts. For the experiments shown in FIG. 4 (Results III-A), the Bio-Rad urinalysis control was diluted 10× into 1% low-melting point agar in PBS. The use of agar for these experiments enabled particles in the urine phantom to be stationary with time, allowing the acquisition of a hologram with the LFI system 300 and paired axial z-stack acquisition with the GT microscope 305.

FIG. 4. (a) Raw hologram of urinalysis control in low-melting point agar acquired with the LFI system 300. Note this represents only ˜ 1/80^{th} of the total LFI field of view. A single region of interest (ROI) in the hologram (orange box) is highlighted along with its corresponding reconstruction, (f). (b)-(g) Paired ROIs of LFI reconstruction (left) and GT microscope (right). (b) A white blood cell, (c)-(d) red blood cells, (e) a fiber, (f) a cast, and (g) a crystal. Note that the 10 μm scale bar applies to all LFI reconstruction and GT ROIs except the crystal, (g).

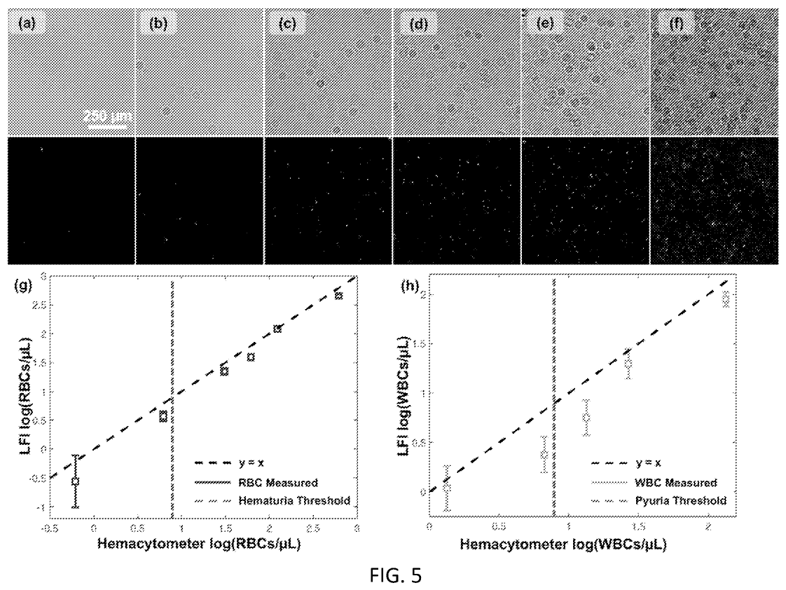

2) RBC and WBC Concentration: Next, the Bio-Rad urinalysis control was diluted in PBS into six discrete concentrations to generate a physiologically relevant range of red blood cell (RBC, 0-600 RBCs/μL) and white blood cell (WBC, 0-130 WBCs/μL) concentrations (FIG. 5, Results III-A). Of note, a threshold of 8 RBCs/μL and 8 WBCs/μL in un-centrifuged urine are typical thresholds used for microscopic hematuria and pyuria, respectively, which is often present in the setting of urinary tract infection [21]-[24]. This experiment was repeated independently five times, and the number of red and white blood cells was counted in the 3D reconstruction volume manually. The mean blood cell counts of these five samples was determined and divided by the sample volume over which the cells were counted to estimate their concentrations. Separately, the RBC and WBC concentrations in the Bio-Rad urinalysis control measured in a hemacytometer (Bright-Line, Z359629) using trypan blue.

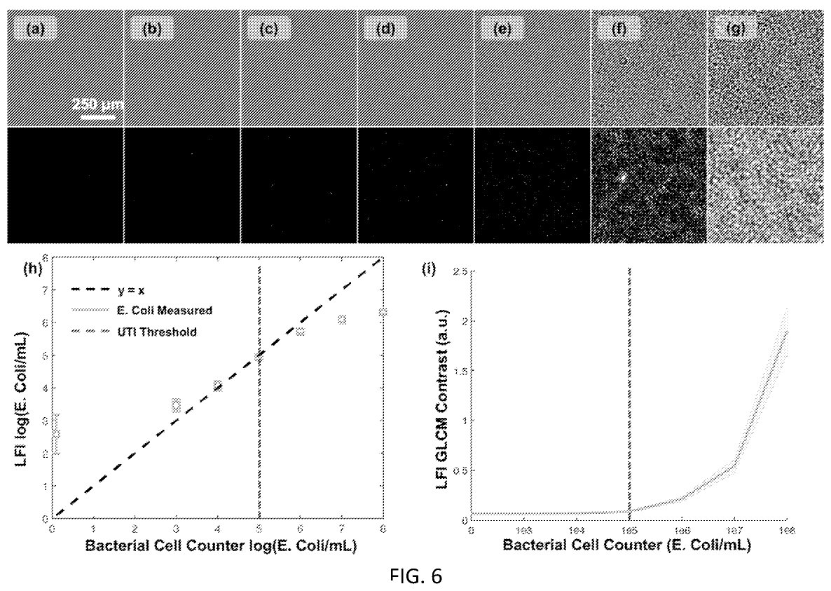

3) E. Coli Concentration: For FIG. 6, (Results III-C), E. Coli were added to PBS to determine the ability of the LFI system 300 to resolve E. Coli and estimate their concentration in solution. E. Coli (ATCC, 39936) were first incubated at 37° C. on Tryptic Soy Agar plates with 100 μg/mL ampicillin (Teknova, 200066-580). A single colony was selected and incubated for 24 hours at 37° C. in LB Broth with 100 μg/mL ampicillin. From this stock solution, E. Coli were pelleted using centrifugation (1 g×10 min) and resuspended in PBS. The concentration of E. Coli was measured using a 20 μm tall Petroff-Hausser bacterial cell counter (Hausser Scientific 3298S22). The stock E. Coli solution in PBS was diluted to cover a physiologically relevant range of concentrations (0, 1e3, 1e4, 1e5, 1e6, 1e7, and 1e8 cells/mL), including the typical threshold for UTI in asymptomatic patients (1e5 cells/mL [21]). Again, a manual counting of reconstructed particles was conducted to estimate the E. Coli concentrations (panel (h) of FIG. 6). E. Coli could not be individually resolved above 1e6 cells/mL, so a textural analysis was also applied based upon the gray-level co-occurrence matrix (GLCM) to the raw holograms (panel (i) of FIG. 6) [25]. This was implemented using pre-defined MATLAB functions (graycomatrix and graycoprops) using 25 intensity levels and a one-pixel lateral offset. Again, the experiment was repeated five times.

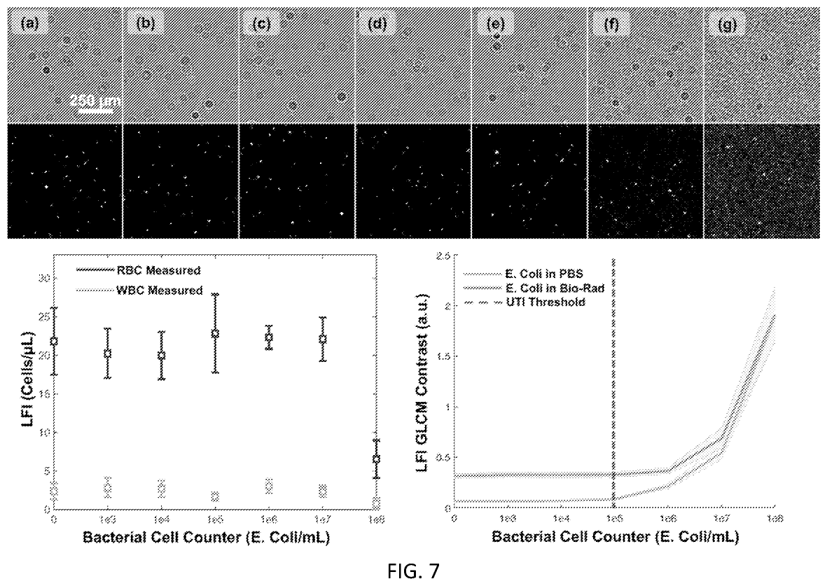

4) E. Coli, RBCs, and WBCs: Next, using a similar protocol of bacterial selection, growth, and centrifugation, E. Coli were pelleted and then resuspended in 20× dilute Bio-Rad urinalysis control, a concentration chosen to have WBCs present at approximately the threshold of pyuria. E. Coli concentration was again varied across 0, 1e3, 1e4, 1e5, 1e6, 1e7, and 1e8 cells/mL, and the concentration of RBCs and WBCs was measured through manual counting of particles in the reconstruction. E. Coli concentration was again estimated using GLCM texture analysis. This experiment was replicated five times, the results of which are shown in FIG. 7, Results III-D.

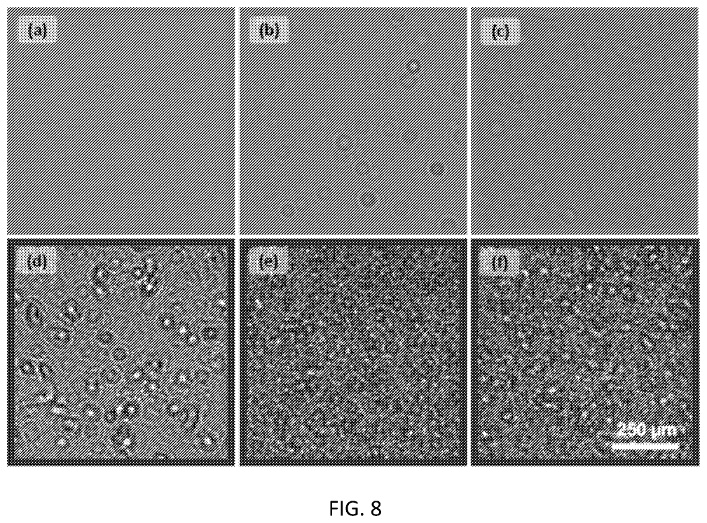

5) Human UTI Sample Imaging: Finally, through an IRB-approved protocol (JHU IRB00283348), discarded urine was acquired from patients at the Johns Hopkins Hospital with paired ground truth diagnosis of positive urinary tract infection (UTI(+)) and negative urinary tract infection (UTI(−)) controls. These samples were imaged in the LFI system, and shown in FIG. 8, Results III-E.

### C. Image Acquisition, Processing, and Reconstruction

Holograms were acquired using a 20 ms exposure and gain setting of 0 dB. Single holograms were used for reconstructing paired imaging data between the LFI system 300 and the GT microscope 305, red and white blood cell concentration estimation (FIG. 5), and patient urine samples (FIG. 8). E. Coli are often similar in size to the wavelength of light used, and scatter relatively weakly as compared to other larger particles such as RBCs, WBCs, and debris. For phantom data where E. Coli is present (FIGS. 6 and 7), videos of 100 frames were acquired at 5 Hz. The time-average image was computed from the 100-frame stack, and subtracted from the original data to remove signal from stationary particles that were present on the coverglass such as dust, streaks, and debris.

To generate reconstructed images from LFI holograms, a 3D sparse phase recovery reconstruction algorithm was implemented [26], [27]. Briefly, sparse regularization is applied to a wide angular spectrum model of diffraction where alternating minimization allows for closed-form updates and recovery of missing phase information in a 3D volume. The model is shown below in Equation (3):

$${min}_{{\{ {X}_{j} \}}_{j = 1}^{D} , W , μ} \frac{1}{2} {‖ H ⊙ W − μ 1 − {\sum }_{j = 1}^{D} T ( z [ j ] ) ⋆ {X}_{j} ‖}_{F}^{2} + λ {\sum }_{j = 1}^{D} {‖ {X}_{j} ‖}_{1} s . t . \vert W \vert = 1. \qquad ( 3 )$$

Here, H is the hologram recorded by the image sensor, Xⱼ is the corresponding image at specified depth z[j], W is the estimated phase, p is the non-zero background modeling planar illumination, T(z) is the diffraction transfer function according to a wide angular spectrum model, and k is the sparsity parameter. For further description see [26], including Algorithm 2 in Supplementary Material for pseudocode. The axial resolution was set to 10 μm, over a 2 mm reconstruction depth, utilized 20 iterations, and a sparsity parameter λ=1.3. For reconstructions shown in FIGS. 5-8, a summed intensity projection over the full 2 mm depth is calculated to display the total number of particles in the 3D volume in a single 2D image.

### III. Results and Discussion

### A. Paired LFI and GT Imaging

It was first sought to demonstrate accurate reconstruction of clinically important urinary biomarkers with the LFI system 300. To do so, a urine phantom was prepared in low melting point agar that enabled the sequential acquisition of data with the LFI system 300 and with the lens-based GT microscope 305. Thus, this sample was illuminated and a hologram acquired with the LFI system 300, and subsequently acquired an axial z-stack of the same sample with the GT microscope 305. A portion of a raw hologram from the LFI system is shown in panel (a) of FIG. 4. Next, the 3D sparse phase recovery reconstruction algorithm was applied to the hologram, and regions of interest of reconstructed particles are shown in panels (b)-(g) (left) of FIG. 4, with the paired image of the same particle from the GT microscope (right). These results demonstrate that the LFI system 300 can resolve particles such as blood cells and crystals in a model of human urine. Note that while a full 7.4 mm×5.55 mm hologram is acquired, only a small portion of this data is shown in panel (a) of FIG. 4. The reconstructed volume in this region is approximately 1 μL of the 82 μL sampled.

FIG. 4. (a) Raw hologram of urinalysis control in low-melting point agar acquired with the LFI system. Note this represents only ˜ 1/80^{th} of the total LFI field of view. A single region of interest (ROI) in the hologram (orange box) is highlighted along with its corresponding reconstruction, (f). (b)-(g) Paired ROIs of LFI reconstruction (left) and GT microscope (right). (b) A white blood cell, (c)-(d) red blood cells, (e) a fiber, (f) a cast, and (g) a crystal. Note that the 10 μm scale bar applies to all LFI reconstruction and GT ROIs except the crystal, (g).

### B. RBC and WBC Concentration

After demonstrating the ability to resolve red and white blood cells with the paired LFI and GT experiments, it was next sought to determine if the concentration of RBCs and WBCs in solution could be measured with the LFI system 300. To do so, the Bio-Rad urinalysis control was diluted and imaged in PBS over six discrete concentrations and the results of the LFI measurement compared to a concentration measured with a hemacytometer. Holograms showing increasing RBC and WBC concentration are shown in panels (a)-(f) of FIG. 5 with the corresponding reconstruction shown below. Note the reconstructions are displayed as a summed intensity projection across the full 2 mm sample reconstruction height to enable viewing the particles at different axial locations in the field of view in a single 2D image. The red and white blood cells were counted manually and divided by the reconstructed sample volume to provide an estimation of the RBC and WBC concentrations (panels (g) and (h) of FIG. 5).

From these data, a few important findings emerge. First, a strong linear correlation was observed between the concentration estimation in the LFI system 300 and from the hemacytometer with R²=0.9941 and R²=0.9973 for the RBC and WBC concentrations, respectively. However, despite the strong linear correlation in the data, it was observed that for both RBC and WBC concentration estimation, the LFI system 300 under-estimates the cellular concentration, a trend which becomes more pronounced as concentration increases. It can be seen, at the highest concentration imaged, that the holograms from individual particles (panel (f) of FIG. 5, top) become quite crowded and are no longer individually separated. At this concentration, the reconstructions (panel (f) of FIG. 5, bottom) become noisy. This is believed to be due to the model of diffraction breaking down at high particle concentrations when holograms from objects further from the sensor begin to interfere with objects closer to the sensor. While this could be ameliorated with a thinner sample, the 2 mm sample height used here is believed to provide accurate reconstruction over the most relevant concentration range. Of particular importance, the LFI system 300 is sensitive to changes in RBC and WBC concentrations around the critical ranges of microscopic hematuria and pyuria in non-centrifuged urine, highlighted by the red vertical dashed lines in panels (g) and (h) of FIG. 5.

These results demonstrate that LFI is a promising technique for measuring hematuria and pyuria with proper calibration to account for under-estimation at the higher concentrations. This capability would provide utility beyond the use case of urinary tract infection screening, as hematuria and pyuria also occur in the setting of acute kidney injury, stones, and malignancy of the genitourinary tract [5], [22], [28].

FIG. 5. Red and white blood cell concentration estimation using LFI. (a)-(f) Raw hologram (top) and corresponding 2D summed intensity projection of 3D reconstructed volume (bottom) with increasing concentration. Concentration estimation of (g) red blood cells and (h) white blood cells using LFI vs. a Hemacytometer. Dashed lines represent the ideal curve (y=x), while measured mean data are shown as the solid curve. Error bars show ±one standard deviation.

### C. E. Coli Concentration

Next, the LFI system 300 was tested to see if it could resolve individual E. Coli, despite their size being a similar order of magnitude to the wavelength of light. Previous studies applying lens-less imaging to bacteria demonstrate very weak scattering that has required the development and application of thin wetting films to improve signal-to-noise ratio (SNR) of the hologram [29], [30]. However, because the aim is to image particles in untreated urine without laboratory processing, a technique such as this is precluded. To test the ability of the LFI system 300 to resolve E. Coli and estimate concentration, simple UTI phantoms were created where E. Coli concentration was varied in PBS spanning above and below the typical UTI concentration threshold of 1e5 cells/mL. Panels (a)-(g) of FIG. 6 show the holograms from this experiment with increasing concentration from left to right (0, 1 e3, 1e4, 1e5, 1e6, 1e7, and 1e8 cells/mL). The corresponding reconstruction of these holograms is shown below each panel of the figure as a log-intensity of the summed projection to enable viewing the results across the wide range of concentrations under study. It is possible to see the holograms created by individual E. Coli bacteria and their corresponding reconstructions at concentrations up to 1e6 cells/mL, however at concentrations higher than this, one begins to see significant hologram overlap and noise in the corresponding reconstruction. Interestingly, in place of the individual holograms, instead a textural change appears, that is similar to speckle noise [31].

By manually counting the number of E. Coli particles localized in each image stack and dividing by the volume that is reconstructed, an estimation of E. Coli concentration is generated from the LFI system 300. When plotting these results against ground truth concentration measurements determined with a Petroff-Hausser bacterial cell counter (panel (h) of FIG. 6), it can be seen that LFI demonstrates accurate estimation over the most clinically important range of 1e3 cells/mL to 1e6 cell/mL. However, at lower concentration, the LFI system 300 over-estimates the number of bacteria, likely from small particles of debris in the sample being misclassified as E. Coli. Above 1e6 cells/mL, the LFI system 300 begins to under-estimate the true E. Coli concentration. This trend is similar to the RBC and WBC concentration estimates of panels (g) and (h) of FIG. 5, and again occurs at approximately the concentration where individual holograms are no longer resolved and the reconstructions become noisy. With the failure of accurate concentration estimation above the UTI threshold with manual cell counting from reconstructions, it was sought to instead exploit the speckle-like, textural changes that become visible in the holograms of these higher concentrations. The gray-level co-occurrence matrix (GLCM) was implemented, which is a computationally-efficient textural analysis tool that quantifies how frequently intensity values occur in pre-defined spatial patterns in the image. The GLCM contrast of the LFI holograms in plotted vs. E. Coli concentration in panel (i) of FIG. 6, which demonstrates a clear positive correlation with concentration above the UTI threshold. Thus, with a two-part algorithm, with manual counting at low concentrations and textural analysis at high concentrations, it is possible to estimate E. Coli concentration with the LFI system 300 across five orders of magnitude.

FIG. 6. E. Coli concentration estimation in PBS. (a)-(g) Holograms (top) and corresponding summed intensity projections of reconstructions (bottom) of increasing concentration of E. Coli (0, 1e3, 1e4, 1e5, 1e6, 1e6, and 1e8 cells/mL, respectively). Each field-of-view shows approximately 1 μL of sample. (h) Manual counting of cells yields concentration estimations (yellow data points) that are accurate below the UTI threshold (red dashed line), however under-estimate E. Coli concentration above the UTI threshold. (i) Gray-level co-occurrence matrix contrast vs. E. Coli concentration shows a positive correlation above the UTI threshold.

### D. E. Coli, RBCs, and WBCs

The use of PBS as the solvent for testing E. Coli concentration in Results III-C provides a basic model of UTI, however, ignores the fact that patients often have other large particles such as RBCs and WBCs present in their urine in the setting of UTI. To model this, E. Coli was next added to Bio-Rad urinalysis control diluted in PBS such that the WBC concentration was near the pyuria threshold. Samples were again created with concentrations of E. Coli spanning above and below the UTI threshold (0, 1e3, 1e4, 1e5, 1e6, 1e7, and 1e8 cells/mL), and imaged them with the LFI system. FIG. 7 summarizes these results, with panels (a)-(g) showing the hologram (top) and corresponding reconstruction (bottom) with increasing E. Coli concentration from left to right.

The SNR from blood cell holograms is much stronger than from the weakly scattering E. Coli particles, which is readily apparent both in the holograms and the reconstructions. While a linear increase was observed in the number of individual E. Coli holograms and corresponding reconstructed bacteria when they were in PBS (FIG. 6), a similar trend was not observed when the E. Coli are mixed with blood cells. Unfortunately, it appears that individual E. Coli are not resolvable when mixed with blood cells at this concentration. However, despite this failure, it is possible to reconstruct and accurately measure the concentration of RBCs and WBCs as E. Coli concentration increases up through 1e7 cells/mL.

Finally, though E. Coli reconstruction and concentration estimation fails below the UTI threshold, the same characteristic change in texture is seen in the holograms at and above 1e6 cells/mL that we observed when PBS was the solvent (FIG. 6). Thus, when applying the GLCM textural analysis to the data, a similar trend is observed, which is demonstrated in panel (i) of FIG. 7 as the green curve. For comparison, the yellow curve is the same data from panel (i) of FIG. 6, where E. Coli was dissolved in PBS. Note that the strong holograms from RBCs and WBCs provide a vertical offset to the GLCM contrast signal at the low concentrations of E. Coli. However, similar to when PBS is the solvent, the GLCM contrast still correlates with higher concentrations of E. Coli, as speckle-like signal prevails over the stronger SNR holograms from the blood cells. Further, at the highest concentration of E. Coli, a marked drop is observed in the number of reconstructed blood cells, which appears to affect the RBC concentration estimation more. White blood cells could be less prone to this phenomena because they are typically larger than RBCs and have more complex sub-cellular features that diffract light.

FIG. 7. Red blood cell (RBC), white blood cell (WBC), and E. Coli concentration estimation in Bio-Rad urinalysis control. (a)-(g) Holograms (top) and corresponding summed intensity projections of reconstructions (bottom) of increasing concentration of E. Coli (0, 1e3, 1e4, 1e5, 1e6, 1e6, and 1e8 cells/mL, respectively) with constant concentration of RBCs and WBCs. (h) Manual counting of cells yields consistent concentration estimations of RBCs and WBCs (red solid line, blue solid line, respectively) until E. Coli concentration of 1e8 cells/mL. (i) Gray-level co-occurrence matrix contrast vs. E. Coli concentration quantifies textural changes that occur at higher E. Coli Concentrations in the Bio-Rad urinalysis control (green) as compared to PBS (FIG. 4(i), yellow).

### E. Human UTI Sample Imaging

Next, the LFI system 300 was tested for UTI screening by acquiring and imaging human urine samples with known positive UTI diagnosis (UTI(+)) and known negative UTI controls (UTI(−)). These data are shown in panels (a)-(f) of FIG. 6, where UTI(+) are highlighted in a red box and UTI(−) cases are highlighted in a green box. These holograms, taken directly by the LFI system 300 without any processing, show a clear difference in signal across the two classes. UTI(+) cases show numerous large, high SNR holograms surrounded by higher spatial frequency texture, which is qualitatively similar to what was observed in model UTI phantoms with hematuria and pyuria (panels (f) and (g) of FIG. 7). However, though a qualitative difference is apparent between the UTI(−) and UTI(+) cases, the exact sensitivity of LFI to UTI diagnosis at the UTI threshold is not discemable from this preliminary data. Further, though the UTI(−) cases do show fewer, weaker SNR holograms and less texture, there are still particles present in the sample, and there appears to be significant variability in the number of particles across UTI(−) cases. Note that because no average background subtraction algorithm has been applied to these data, some of these are stationary particles, such as dust and debris on the coverglass and sensor. However, many of the particles in the UTI(−) cases are in solution, and are likely a complex, heterogenous mixture of urothelial cell debris, crystals, sperm, and mucous. Further work must be done to calibrate LFI imaging to the variability present in human urine, and it will be interesting to study how phenomena such as hydration, pH, temperature, and time of day affect the urine composition and resulting LFI signal. Thus, promising preliminary results are observed in the ability of LFI to distinguish between UTI(+) and UTI(−) samples, though significant work remains to fully understand the complexity of urine composition and correlation to LFI data in health and disease.

FIG. 8. (a)-(c) LFI holograms of human urine negative UTI controls (green boxes), and (d)-(f) holograms with positive UTI diagnosis (red boxes).

### IV. Conclusion

Lens-free imaging provides a compact, low-cost method of assessing large volumes of weakly scattering material. These strengths make it a natural fit for bedside, point-of-care urinary tract infection screening if it is able to detect hematuria, pyuria, and bacteriuria. Here, an LFI system 300 is demonstrated that can resolve and estimate the concentration red blood cells, white blood cells, and bacteria over clinically important ranges using a 3D sparse phase recovery reconstruction algorithm and textural analysis. Further, LFI holograms show qualitative differences between human urine with positive UTI diagnoses and negative controls. These results demonstrate that LFI is a promising technology for urine tract infection screening.

Some embodiments of this technology may be implemented with a flow cell, directly in-line with an in-dwelling catheter to enable urinalysis screening at the bedside in real-time. Further, variability in urine composition may correlate to LFI signal in both health and disease. This technology could alleviate issues with handling human waste and enable real-time trend analysis that yields early detection of UTI, kidney injury, and other conditions in the genitourinary tract. Finally, this technology could be readily adapted to provide urine screening in low-resource settings where conventional laboratory equipment is unavailable.

### REFERENCES

[1]K. Gupta, L. Grigoryan, and B. Trautner, “Urinary Tract Infection,” Annals of Internal Medicine, vol. 167, no. 7, pp. ITC49-ITC64, 2017.
[2]M. Medina and E. Castillo-Pino, “An introduction to the epidemiology and burden of urinary tract infections,” Therapeutic Advances in Urology, vol. 11, no. 3-7, 2019.
[3]S. Saint, “Clinical and economic consequences of nosocomial catheter-related bacteriuria,” American Journal of Infection Control, vol. 28, no. 1, pp. 68-75, 2000.
[4]W. E. Stamm, “Catheter-associated urinary tract infections: Epidemiology, pathogenesis, and prevention,” The American Journal of Medicine, vol. 91, no. 3B, 1991.
[5]V. J. Sharp, K. T. Barnes, and B. A. Erickson, “Assessment of asymptomatic microscopic hematuria in adults,” American Family Physician, vol. 88, no. 11, pp. 747-754, 2013.
[6]P. A. Tambyah and D. G. Maki, “The relationship between pyuria and infection in patients with indwelling urinary catheters: A prospective study of 761 patients,” Archives of Internal Medicine, vol. 160, no. 5, pp. 673-677, 2000.
[7]A. J. Rai, “The Urinary Proteome Methods and Protocols,” Methods in Molecular Biology. Springer New York, pp. 1-12, 2010.
[8]J. A. Simerville, W. C. Maxted, and J. J. Pahira, “Urinalysis: A comprehensive review,” American Family Physician, vol. 71, no. 6, pp. 1153-1162, 2005.
[9]X. Wu, “Urinalysis: A Review of Methods and Procedures,” Critical Care Nursing Clinics of North America, vol. 22, no. 1, pp. 121-128, 2010.
[10]M. T. Larocco, J. Franek, E. K. Leibach, A. S. Weissfeld, C. S. Kraft, R. L. Sautter, V. Baselski, D. Rodahl, E. J. Peterson, and N. E. Cornish, “Effectiveness of preanalytic practices on contamination and diagnostic accuracy of urine cultures: A laboratory medicine best practices systematic review and meta-analysis,” Clinical Microbiology Reviews, vol. 29, no. 1, pp. 105-147, 2015.
[11]W. Xu, M. H. Jericho, I. A. Meinertzhagen, and H. J. Kreuzer, “Digital in-line holography for biological applications,” Proceedings of the National Academy of Sciences of the United States of America, vol. 98, no. 20, pp. 11 301-11 305, 2001.
[12]S. Seo, T. W. Su, D. K. Tseng, A. Erlinger, and A. Ozcan, “Lensfree holographic imaging for on-chip cytometry and diagnostics,” Lab on a Chip, vol. 9, no. 6, pp. 777-787, 2009.
[13]T. W. Su, L. Xue, and A. Ozcan, “High-throughput lensfree 3D tracking of human sperms reveals rare statistics of helical trajectories,” Proceedings of the National Academy of Sciences of the United States of America, vol. 109, no. 40, pp. 16 18-16 22, 2012.
[14]G. Pedrini and H. J. Tiziani, “Short-coherence digital microscopy by use of a lensless holographic imaging system,” Applied Optics, vol. 41, no. 22, p. 4489, 2002.
[15]L. Repetto, E. Piano, and C. Pontiggia, “Lensless digital holographic microscope with light-emitting diode illumination,” Optics Letters, vol. 29, no. 10, p. 1132, 2004.
[16]J. Garcia-Sucerquia, W. Xu, M. H. Jericho, and H. J. Kreuzer, “Immersion digital in-line holographic microscopy,” Optics Letters, vol. 31, no. 9, p. 1211, 2006.
[17]T. M. Kreis, W. P. O. Jueptner, and J. Geldmacher, “Digital holography: methods and applications,” International Conference on Applied Optical Metrology, vol. 3407, no. September 1998, pp. 169-177, 1998.
[18]M. K. Kim, Digital Holographic Microscopy. Principles, Techniques, and Applications, 2009.
[19]S. O. Isikman, I. Sencan, O. Mudanjali, W. Bishara, C. Oztoprak, and A. Ozcan, “Color and monochrome lensless on-chip imaging of Caenorhabditis elegans over a wide field-of-view,” Lab on a Chip, vol. 10, no. 9, 2010.
[20]M. Riley, “Size Limits of Very Small Microorganisms: Correlates of Smallest Sizes for Microorganisms,” in Size Limits of Very Small Microorganisms, 1999, pp. 21-25.
[21]W. E. Stamm, “Measurement of pyuria and its relation to bacteriuria,” The American Journal of Medicine, vol. 75, pp. 53-58, 1983.
[22]L. G. Feld, W. R. Waz, L. M. Perez, and D. B. Joseph, “Hematuria: An integrated medical and surgical approach,” Pediatric Clinics of North America, vol. 44, no. 5, pp. 1191-1210, 1997.
[23]L. Wang, H. Wang, C. Zhao, and C. Chen, “The standardization of the report for urine cell counting—A converting factor for Sysmex UF-1000i,” Journal of Clinical Laboratory Analysis, vol. 33, no. 4, pp. 1-5, 2019.
[24]K. Hannemann-Pohl and S. C. Kampf, “Automation of urine sediment examination: A comparison of the Sysmex UF-100 automated flow cytometer with routine manual diagnosis (microscopy, test strips, and bacterial culture),” Clinical Chemistry and Laboratory Medicine, vol. 37, no. 7, pp. 753-764, 1999.
[25]R. M. Haralick, I. Dinstein, and K. Shanmugam, “Textural Features for Image Classification,” IEEE Transactions on Systems, Man and Cybernetics, vol. SMC-3, no. 6, pp. 610-621, 1973.
[26]B. D. Haeffele, R. Stahl, G. Vanmeerbeeck, and R. Vidal, “Efficient Reconstruction of Holographic Lens-Free Images by Sparse Phase Recovery,” MICCAI, vol. II, pp. 109-117, 2017.
[27]B. D. Haeffele, C. Pick, Z. Lin, E. Mathieu, S. C. Ray, and R. Vidal, “Generative optical modeling of whole blood for detecting platelets in lens-free images,” Biomedical Optics Express, vol. 11, no. 4, pp. 1808-1818, 2020.
[28]A. J. Mariani, M. C. Mariani, C. Macchioni, U. K. Stains, A. Hariharan, and A. Moriera, “The significance of adult hematuria: 1,000 hematuria evaluations including a risk-benefit and cost-effectiveness analysis,” Journal of Urology, vol. 141, no. 2, pp. 350-355, 1989.
[29]V. Poher, C. P. Allier, J. G. Coutard, L. Herve', and J. M. Dinten, “Lensfree in-line holographic detection of bacteria,” Optics InfoBase Conference Papers, vol. 8086, pp. 1-7, 2011.
[30]C. P. Allier, G. Hiernard, V. Poher, and J. M. Dinten, “Bacteria detection with thin wetting film lensless imaging,” Biomedical Optics Express, vol. 1, no. 3, p. 762, 2010.
[31]J. W. Goodman, Speckle Phenomena in Optics: Theory and Applications, second edi ed. SPIE Press, 2020.

The system includes a number of components that each may be implemented on a server or on an end-user device. In some cases, a subset of the components may execute on a user device (e.g., a mobile application on a cell phone, a webpage running within a web browser, a local application executing on a personal computer, etc.) and another subset of the components may execute on a server (a physical machine, virtual machine, or container, etc., which may be located at a datacenter, a cloud computing provider, a local area network, etc.).

The components of the system may be implemented in some embodiments as software programs or modules, which are described in more detail below. In other embodiments, some or all of the components may be implemented in hardware, including in one or more signal processing and/or application specific integrated circuits. While the components are shown as separate components, two or more components may be integrated into a single component. Also, while many of the components' functions are described as being performed by one component, the functions may be split among two or more separate components.

The terms “light” and “optical” are intended to have broad meanings that can include both visible regions of the electromagnetic spectrum as well as other regions, such as, but not limited to, infrared and ultraviolet light and optical imaging, for example, of such light.

The terms “computer”, “server”, “processor”, and “memory” all refer to electronic or other technological devices. These terms exclude people or groups of people. As used in this specification, the terms “computer readable medium,” “computer readable media,” and “machine readable medium,” etc. are entirely restricted to tangible, physical objects that store information in a form that is readable by a computer. These terms exclude any wireless signals, wired download signals, and any other ephemeral signals.

The term “computer” is intended to have a broad meaning that may be used in computing devices such as, e.g., but not limited to, standalone or client or server devices. The computer may be, e.g., (but not limited to) a personal computer (PC) system running an operating system such as, e.g., (but not limited to) MICROSOFT® WINDOWS® available from MICROSOFT® Corporation of Redmond, Wash., U.S.A. or an Apple computer executing MAC® OS from Apple® of Cupertino, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. The computer system may include, e.g., but is not limited to, a main memory, random access memory (RAM), and a secondary memory, etc. Main memory, random access memory (RAM), and a secondary memory, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory may include, for example, (but not limited to) a hard disk drive and/or a removable storage drive, representing a floppy diskette drive, a magnetic tape drive, an optical disk drive, a read-only compact disk (CD-ROM), digital versatile discs (DVDs), flash memory (e.g., SD cards, mini-SD cards, micro-SD cards, etc.), read-only and recordable Blu-Ray® discs, etc. The removable storage drive may, e.g., but is not limited to, read from and/or write to a removable storage unit in a well-known manner. The removable storage unit, also called a program storage device or a computer program product, may represent, e.g., but is not limited to, a floppy disk, magnetic tape, optical disk, compact disk, etc. which may be read from and written to the removable storage drive. As will be appreciated, the removable storage unit may include a computer usable storage medium having stored therein computer software and/or data.

In some embodiments, the secondary memory may include other similar devices for allowing computer programs or other instructions to be loaded into the computer system. Such devices may include, for example, a removable storage unit and an interface. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units and interfaces, which may allow software and data to be transferred from the removable storage unit to the computer system.

Some embodiments include electronic components, such as microprocessors, storage and memory that store computer program instructions in a machine-readable or computer-readable medium (alternatively referred to as computer-readable storage media, machine-readable media, or machine-readable storage media). The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

The computer may also include an input device or may include any mechanism or combination of mechanisms that may permit information to be input into the computer system from, e.g., a user. The input device may include logic configured to receive information for the computer system from, e.g., a user. Examples of the input device may include, e.g., but not limited to, a mouse, pen-based pointing device, or other pointing device such as a digitizer, a touch sensitive display device, and/or a keyboard or other data entry device (none of which are labeled). Other input devices may include, e.g., but not limited to, a biometric input device, a video source, an audio source, a microphone, a web cam, a video camera, and/or another camera. The input device may communicate with a processor either wired or wirelessly.

The computer may also include output devices which may include any mechanism or combination of mechanisms that may output information from a computer system. An output device may include logic configured to output information from the computer system. Embodiments of output device may include, e.g., but not limited to, display, and display interface, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. The computer may include input/output (I/O) devices such as, e.g., (but not limited to) communications interface, cable and communications path, etc. These devices may include, e.g., but are not limited to, a network interface card, and/or modems. The output device may communicate with processor either wired or wirelessly. A communications interface may allow software and data to be transferred between the computer system and external devices.

The terms “processor,” “processing unit,” “data processor,” etc. are intended to have a broad meaning that includes one or more processors, such as, e.g., but not limited to, processors that are connected to a communication infrastructure (e.g., but not limited to, a communications bus, cross-over bar, interconnect, or network, etc.). The terms may include any type of processor, microprocessor and/or processing logic that may interpret and execute instructions, including application-specific integrated circuits (ASICs) and field-programmable gate arrays (FPGAs). The data processor may comprise a single device (e.g., for example, a single core) and/or a group of devices (e.g., multi-core). The data processor may include logic configured to execute computer-executable instructions configured to implement one or more embodiments. The instructions may reside in main memory or secondary memory. The data processor may also include multiple independent cores, such as a dual-core processor or a multi-core processor. The data processors may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

The term “data storage device” is intended to have a broad meaning that includes removable storage drive, a hard disk installed in hard disk drive, flash memories, removable discs, non-removable discs, etc. In addition, it should be noted that various electromagnetic radiation, such as wireless communication, electrical communication carried over an electrically conductive wire (e.g., but not limited to twisted pair, CAT5, etc.) or an optical medium (e.g., but not limited to, optical fiber) and the like may be encoded to carry computer-executable instructions and/or computer data that embodiments of the invention on e.g., a communication network. These computer program products may provide software to the computer system. It should be noted that a computer-readable medium that comprises computer-executable instructions for execution in a processor may be configured to store various embodiments of the present invention.

The term “network” is intended to include any communication network, including a local area network (“LAN”), a wide area network (“WAN”), an Intranet, or a network of networks, such as the Internet.

The term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described. For example, it is to be understood that the present disclosure contemplates that, to the extent possible, one or more features of any embodiment can be combined with one or more features of any other embodiment.

1. An analysis system for a translucent bodily fluid, comprising:
a flow chamber for the translucent bodily fluid defining an imaging section therein;
an illumination source arranged to provide illumination light to said imaging section of said flow chamber;
an optical sensor arranged proximate to said flow chamber and arranged to receive light after passing through said flow chamber, said optical sensor providing detection signals; and
a processor arranged to communicate with said optical sensor to receive said detection signals therefrom,
wherein said illumination source provides at least partially coherent light to said imaging section of said flow chamber such that said detection signals correspond to a two-dimensional image, and
wherein said processor is configured to extract information from said two-dimensional image for particles when present within the translucent bodily fluid passing through said flow chamber.

2. The analysis system according to claim 1, wherein said illumination source comprises a substantially monochromatic light-emitting diode (LED) and a pinhole aperture stop arranged between said LED and said imaging section of said flow chamber.

3. The analysis system according to claim 1, wherein said illumination source comprises a laser diode directed onto said imaging section of said flow chamber.

4. The analysis system according to claim 1, wherein said illumination source comprises a plurality of different wavelengths, and each being directed onto said imaging section of said flow chamber.

5. The analysis system according to claim 1, wherein said imaging section of said flow chamber defines a substantially rectangular lumen therein that is arranged to have a flat surface oriented substantially orthogonal to illumination light from said illumination source, said substantially rectangular lumen being thinner in a thickness direction of light travel therethrough to said optical sensor than a cross direction that is substantially orthogonal to said direction of light travel therethrough and substantially orthogonal to a direction of flow of the translucent bodily fluid through said substantially rectangular lumen.

6. The analysis system according to claim 1, wherein said information extracted from said two-dimensional image comprises at least one of an output of said translucent bodily fluid, a flow rate of said translucent bodily fluid, a translucence of said translucent bodily fluid, a clarity of said translucent bodily fluid, and a sparsity of said translucent bodily fluid.

7. The analysis system according to claim 1, wherein said flow chamber further comprises a first end configured to attach to and to be detached from a catheter and a second end configured to attach to and to be detached from a fluid collection device.

8. The analysis system according to claim 1, wherein said flow chamber is an interchangeable flow chamber that is capable of being interchanged while reusing the illumination source, optical sensor, and processor.

9. The analysis system according to claim 8, wherein the interchangeable flow chamber is aligned with respect to the optical sensor with the use of one of alignment rails and magnets.

10. The analysis system according to claim 1, wherein said processor is further configured to extract information from said two-dimensional image by performing an adaptive sparse reconstruction, said adaptive sparse reconstruction comprising:
receiving the two-dimensional image; and
applying an unsupervised learning model to obtain phase retrieval, point spread function (PSF) estimation, and holographic reconstruction,
wherein said PSF is a generalized PSF that accounts for two-dimensional imaging through a system.

11. The analysis system of claim 10, wherein applying said unsupervised learning model comprises solving an optimization problem.

12. The analysis system according to claim 1, wherein the translucent bodily fluid is one of urine, synovial fluid, cerebrospinal fluid, vitreous humor, pleural effusion, peritoneal lavage, peritoneal dialysate, pericardial fluid, serous fluid, and seminal fluid.

13. The analysis system according to claim 1, wherein said particles comprise at least one of bacteria, red blood cells, white blood cells, crystalline particles, urinary casts, bacteria, fungi, parasites, ascites, tumor cells, and birefringent crystals.

14. An adaptive sparse reconstruction (ASR) method for lens-less digital holography, comprising:
receiving a two-dimensional diffraction image of a sample containing a plurality of optical scattering centers that have been illuminated with partially coherent light; and
applying an unsupervised learning model to obtain phase retrieval, point spread function (PSF) estimation, and holographic reconstruction,
wherein said PSF is a generalized PSF that accounts for two-dimensional imaging through a system.

15. The method of claim 14, wherein applying said unsupervised learning model comprises solving an optimization problem.

16. The method of claim 14, wherein said sample is a sample of a translucent bodily fluid, wherein said translucent bodily fluid is one of urine, synovial fluid, cerebrospinal fluid, vitreous humor, pleural effusion, peritoneal lavage, peritoneal dialysate, pericardial fluid, serous fluid, and seminal fluid.

17. The method of claim 16, further comprising using at least one of said phase retrieval, PSF, and holographic reconstruction, to extract information from said two-dimensional diffraction image for particles when present within said translucent bodily fluid.

18. The method of claim 17, wherein said information extracted from said two-dimensional diffraction image comprises at least one of an output of said translucent bodily fluid, a flow rate of said translucent bodily fluid, a translucence of said translucent bodily fluid, a clarity of said translucent bodily fluid, and a sparsity of said translucent bodily fluid.

19. The method of claim 17, wherein said particles comprise at least one of bacteria, red blood cells, white blood cells, crystalline particles, urinary casts, bacteria, fungi, parasites, ascites, tumor cells, and birefringent crystals.

20. A method of analyzing a translucent bodily fluid in a chamber, comprising:
receiving a plurality of detection signals from an optical sensor arranged proximate to said chamber, said optical sensor arranged to receive light from an illumination source after said light passes through at least a portion of said translucent bodily fluid in said chamber;
processing said signals to generate a two-dimensional image; and
performing an adaptive sparse reconstruction to extract information from said two-dimensional image for particles when present within the translucent bodily fluid.

21. The method of claim 20, wherein performing said adaptive sparse reconstruction comprises:
receiving the two-dimensional image; and
applying an unsupervised learning model to obtain phase retrieval, point spread function (PSF) estimation, and holographic reconstruction,
wherein said PSF is a generalized PSF that accounts for two-dimensional imaging through a system.

22. The method of claim 21, wherein applying said unsupervised learning model comprises solving an optimization problem.

23. The method of claim 20, wherein said translucent bodily fluid is one of urine, synovial fluid, cerebrospinal fluid, vitreous humor, pleural effusion, peritoneal lavage, peritoneal dialysate, pericardial fluid, serous fluid, and seminal fluid.

24. The method of claim 20, wherein said information extracted from said two-dimensional image comprises at least one of an output of said translucent bodily fluid, a flow rate of said translucent bodily fluid, a translucence of said translucent bodily fluid, a clarity of said translucent bodily fluid, and a sparsity of said translucent bodily fluid.

25. The method of claim 20, wherein said particles comprise at least one of bacteria, red blood cells, white blood cells, crystalline particles, urinary casts, bacteria, fungi, parasites, ascites, tumor cells, and birefringent crystals.

26. Non-transient, computer executable code which when executed by a computer causes the computer to perform the method of claim 13.

27. (canceled)

28. Non-transient, computer executable code which when executed by a computer causes the computer to perform the method of claim 20.

29. (canceled)
